(19) United States
(12) Patent Application Publication
(10) Pub. No.: US 2014/0363712 A1
(43) Pub. Date: Dec. 11, 2014

(54) Hard Shell Housing Comprising Superhydrophobic Material

(71) Applicants: Robert Bosch GmbH, Stuttgart (DE); Samsung SDI Co., Ltd., Yongin-si, Gyeonggi-do (KR)

(72) Inventors: Thomas Wöhrle, Munchen (DE); Joachim Fetzer, Bad-Ditzenbach (DE); Holger Fink, Stuttgart (DE)

(21) Appl. No.: 14/364,841

(22) PCT Filed: Sep. 16, 2012
(86) PCT No.: PCT/EP2012/072887

§ 371 Date: Jun. 12, 2014

(30) Foreign Application Priority Data
Dec. 15, 2011 (DE) 10 2011 088 636.2

(51) Int. Cl. H01M 2/02; H01M 10/0525

(52) U.S. Cl. CPC H01M 2/0292; H01M 10/0525
USPC 429/94; 429/163; 429/149

(57) ABSTRACT

Hard shell housings for electrochemical elements include a main housing element that has an interior space configured to accommodate cell components, at least one electrochemical cell, and a housing lid configured to close off the interior space of the main housing element. The main housing element is formed at least substantially from plastic, and the main housing element comprises at least one superhydrophobic material.

The present invention relates to hard shell housings for galvanic elements, to packaging films for galvanic elements, to galvanic elements provided with corresponding hard shell housings or packaging films, to methods for the production thereof and also to vehicles equipped with corresponding galvanic elements.

### PRIOR ART

It is becoming apparent that, in the future, battery systems will increasingly be used for stationary applications, for example solar and wind power plants, for mobile applications, for example vehicles, such as hybrid and electric vehicles, and in the consumer sector, for example laptops and cell phones, these systems having to meet very high requirements with respect to safety, reliability, power and lifetime.

An important parameter for the power is the energy density, which is given for example in watt-hours per kilogram (Wh/kg). The capacity of a galvanic cell is determined by what is known as the active or electrochemically active materials. Apart from these materials, galvanic cells also have what are known as passive materials, such as separators, insulators, electrode binders and housing or package elements, the weight of which, like the weight of the active materials, has an influence on the energy density.

Predestined for a wide area of use are, in particular, lithium-ion cells, since they are distinguished inter alia by high energy densities of the active materials and an extremely low self-discharge. Lithium-ion cells have a positive electrode (cathode) and negative electrode (anode). The active material of the negative electrode (anode) of a lithium-ion cell is designed here for the reversible insertion (intercalation) of lithium ions (Li⁺) or extraction (deintercalation) again of lithium ions (Li⁺), and is therefore also referred to as intercalation material. Conventionally, graphite is used on the anode side as intercalation material.

Another attractive battery system is that of rechargeable metallic lithium systems, which likewise have a positive electrode (cathode) and negative electrode (anode), in which however the active material of the negative electrode (anode) is not lithium-intercalating material, but metallic lithium or a lithium alloy.

In order to protect lithium cells from environmental influences, in particular from any entry of moisture into the interior of the cell, metallic housings or packaging films are conventionally used.

In order to achieve great mechanical stability and meet high safety requirements, for example in the case of vehicles, lithium-ion cells and lithium cells with a metallic lithium anode for applications with high safety requirements are conventionally protected by purely metallic hard shell housings, known as hard case housings. At present, such hard shell housings are usually produced from aluminum by cold deep-drawing methods. Apart from mechanical protection, metallic hard shell housings also protect the components of the cell(s) housed therein from moisture, since the metallic housing material also serves as a moisture or vapor barrier.

### DISCLOSURE OF THE INVENTION

The subject matter of the present invention is a hard shell housing for a galvanic element which comprises
a housing main body with an interior space for accommodating the cell components of at least one galvanic cell, and
a housing cover for closing off the interior space of the housing main body,
   wherein the housing main body is formed at least substantially from plastic and comprises at least one superhydrophobic material.

A galvanic element may be understood in particular as meaning a component which comprises one or more galvanic cells. A galvanic element may therefore be both a galvanic element with multiple galvanic cells, such as a battery or what is known as a pack or what is known as a module, and an individual galvanic cell. In this case, a module may be understood in particular as being a galvanic element which comprises ≧2 to ≦20, for example ≦2 to ≦10, for example ≧4 to ≦6, cells. The pack may in this case be understood in particular as meaning a galvanic element which comprises two or more modules. Both a module and a pack may be understood as a battery.

The cell components of a galvanic cell may be understood in particular as meaning the electrochemically active components of a galvanic cell, such as the anode, the cathode, the electrolyte and/or the conductive salt, and also electrical components, such as electrical outgoing conductors, electrical insulators and/or separators within the galvanic cell.

The superhydrophobic material may be understood in particular as meaning a material with extremely water repellent properties. The contact angle may be used as a measure for the hydrophoby, that is to say the water repellent properties; the greater the contact angle, the more hydrophobic the surface. For example, a material in relation to the surface of which a water droplet forms a contact angle of ≧135° may be regarded as superhydrophobic. In particular, a material in relation to the surface of which a water droplet forms a contact angle of ≧140°, for example ≧150°, in particular ≧160°, may be regarded as superhydrophobic.

The fact that the housing main body is formed substantially from plastic and not from metal, as in the case of conventional hard shell housings, means that the weight of the housing and the costs of its material and production can be advantageously reduced significantly. A reduced weight in turn allows the specific gravimetric energy at the cell level to be advantageously improved significantly, which is of particular interest in particular for use in mobile applications.

Since the amount of material for forming the housing cover is less than the amount of material for forming the housing main body, the material weight of the housing cover has less of an effect on the total weight of the hard shell housing than the material weight of the housing main body. It is therefore possible in principle to form the housing cover from metal.

However, within the scope of one embodiment, both the housing main body and the housing cover are formed at least substantially from plastic, wherein the housing main body and the housing cover comprise at least one superhydrophobic material.

The fact that the housing main body and the housing cover are formed at least substantially from plastic and not from metal, like conventional hard shell housings, means that the weight of the housing and the costs of its material and production can be advantageously reduced further, and consequently the specific gravimetric energy at the cell level can be improved further.

Moreover, plastic has electrically insulating properties and, by contrast with metals, is not electrically conducting. This offers the advantage of simplifying the electrical insulation and avoiding insulating problems that otherwise occur in the high-voltage area.

The fact that the housing main body can be closed off by the housing cover means that cells accommodated therein are also advantageously not open, are electrically insulated with respect to the outside and can be protected well from the effects of external mechanical forces by the hard shell housing. Moreover, since the housing is formed substantially from plastic, the risk of metallic fragments of the housing getting into the cells, for example in the event of an accident, which could possibly lead to an internal short-circuit, can be reduced. In this way, safety can be increased in particular. This is of advantage in particular for use in mobile applications, for example in a vehicle.

Moreover, the forming of the housing from plastic as opposed to forming of the housing from metal offers the advantage of free shaping of the housing. In this way, for example, better adaptation of the housing to the form of the roll can take place. For example, in the interior space of the housing there may be rounding, which for example makes the cell component pack, in particular roll pack, approximate to an ideally prismatic form. Furthermore, better mechanical securement of the cell components in the housing can be achieved in this way and there is no need for retainers for keeping the cells in position. In addition, an optimized design of the housing makes it possible for empty space and unconfined liquid electrolyte in the interior of the cell to be eliminated, thermal transitions to be improved, a more uniform temperature distribution to be achieved and the lifetime of the galvanic element to be prolonged. Furthermore, forming the housing from plastic makes it possible to reduce vibrations, which in turn has advantageous effects on the lifetime of electrical contacts, for example between terminals and/or collectors and cell-connecting outgoing conductor elements.

It has been found that the (water) vapor permeability of plastics depends on the chemical and physical nature of the plastic and that it is not readily possible with plastics that are usually used for constructing the housings and are inexpensive to achieve a vapor impermeability that meets the standards for alkali metal cells, and in particular for lithium-ion cells. Pleasingly, however, it has likewise been found that this can be counteracted by the use of a superhydrophobic material, since the superhydrophobic material can be used to prevent penetration of moisture by permeation of water vapor through an otherwise vapor-permeable plastic, and thus a moisture or vapor impermeability that is also suitable for alkali metal cells, and in particular lithium-ion cells, can be achieved. Surprisingly, layers of superhydrophobic materials may even be as much of a barrier to water molecules as conventionally used rolled aluminum foil. In this way, protection from environmental influences, such as salt spray, condensed water, can be advantageously ensured by the hard shell housing. Moreover, a superhydrophobic layer can also be used to prevent any possible diffusing out of electrolyte solvent molecules.

It is therefore advantageously possible by the combination of plastic and a superhydrophobic material to provide a hard shell housing of low weight that can be similarly or even equally mechanically stable and vapor-blocking as conventional metallic hard shell housings, and consequently is suitable in particular for galvanic elements with moisture-sensitive components, such as alkali metal cells, for example lithium cells, and makes it possible to replace existing metallic housings for galvanic elements.

An alkali metal cell may be understood in particular as meaning a galvanic cell which comprises an alkali metal, such as lithium or sodium, as the electrochemically active material, for example anode material.

A lithium cell may be understood in particular as meaning a galvanic cell which comprises lithium as the electrochemically active material, for example anode material. In this case, a lithium cell may be understood as meaning both a galvanic cell with a metallic lithium anode, such as a lithium oxygen cell, and a galvanic cell with a lithium-intercalating anode, such as a lithium-ion cell.

A housing main body or housing cover formed at least substantially from plastic may be understood in particular as meaning that the material volume of the housing main body or housing cover that is taken up by plastic is in particular at least more than 75 percent of the total material volume of the housing main body or housing cover. For example, the material volume of the housing main body or housing cover that is taken up by plastic may in this case be ≧90 percent of the total material volume of the housing main body or housing cover. In particular, in this case at least the supporting portions of the housing main body or housing cover may be formed from plastic. In addition, a housing main body or housing cover formed at least substantially from plastic may have portions of other materials. For example, the housing main body or housing cover may have portions which comprise a non-plastic-based superhydrophobic material and/or metallic elements, such as electrical interfaces, known as external terminals, and/or hydraulic interfaces and/or interface bushings. With respect to the total material volume of the housing main body or housing cover, the portions of the housing main body or housing cover that are formed from materials other than plastic may for example take up altogether a material volume of <75%, for example of <10%.

It is possible that the housing main body or the housing cover is produced exclusively or virtually exclusively from plastic. In the case of use of a plastic-based superhydrophobic material, the housing main body or the housing cover may for example be formed exclusively from plastic. Since only little material is required to achieve a superhydrophobic effect, it is still possible in the case where a semimetal-based, superhydrophobic material is used, for example, for the housing main body or the housing cover to be referred to for example as being formed virtually exclusively from plastic, even if the housing main body or the housing cover comprises a small amount of semimetal.

Within the scope of a further embodiment, the at least one galvanic cell is a lithium-ion cell.

Lithium-ion cells represent a special form of lithium cells and do not have a metallic lithium anode, but an anode of what is known as an intercalation material, for example graphite, in which lithium ions can be reversibly inserted (intercalated) and extracted again (deintercalated). Lithium-ion cells also differ from lithium cells with a metallic lithium anode in that lithium-ion cells contain a generally extremely moisture-sensitive conductive salt, for example lithium hexafluorophosphate (LiPF₆), which under some circumstances can hydrolyze in the presence of water to form hydrogen fluoride (HF). The superhydrophobic layer advantageously makes it possible to prevent penetration of moisture, in particular in the form of water vapor, through the plastic into the interior of the housing, and consequently a hydrolysis of the conductive salt of the lithium-ion cell into hydrogen fluoride.

Within the scope of a further embodiment, the interior space of the housing main body is designed for accommodating at least one cell roll of a galvanic cell.

A cell roll (“jelly roll”) may be understood in particular as meaning a special, that is roll-shaped, arrangement of the cell components of a galvanic cell. A cell roll may for example be a roll-shaped component which comprises along with the electrochemically active components of a galvanic cell electrical outgoing conductor elements, such as outgoing conductor foils, and also electrical insulating elements, such as one or more insulating films and/or one or more separator films.

The superhydrophobic material may in particular be based on silicon or polyolefin. The superhydrophobic properties may in this case be achieved in particular by a structuring, in particular in the nanometer range, by analogy with what is known as the Lotus effect.

Within the scope of a further embodiment, the superhydrophobic material therefore takes the form of a superhydrophobic, nanostructured layer.

Within the scope of a further embodiment, the superhydrophobic material or the superhydrophobic, nanostructured layer comprises at least one nanostructured polyolefin, for example nanostructured polypropylene (PP) and/or polyethylene (PE), and/or at least one nanostructured semimetal, for example nanostructured silicon. In particular, the superhydrophobic material or the superhydrophobic, nanostructured layer may be formed from at least one nanostructured polyolefin, for example nanostructured polypropylene (PP) and/or polyethylene (PE), and/or at least one nanostructured semimetal, for example nanostructured silicon.

These superhydrophobic materials have the advantage that—even when they are in direct contact with electrochemically active cell components, such as the organic carbonates and/or lithium conductive salt—they can have great chemical and electrochemical long-term stability. It has advantageously been possible to obtain particularly good results with nanostructured polypropylene (PP).

Within the scope of a further embodiment, at least the surfaces of the housing main body or of the housing main body and of the housing cover that are lying on the outside in the closed state of the housing are covered, in particular substantially completely, with a layer of superhydrophobic material. In addition to the advantages already explained, the application of an outer superhydrophobic layer may advantageously have a self-cleaning effect of the hard shell housing with respect to dirt particles and dust. In this case, the self-cleaning effect may be based inter alia on the principle that, when they roll off from the superhydrophobic surface, water droplets also remove dirt particles.

Within the scope of a further embodiment, at least the surfaces of the housing main body or of the housing main body and of the housing cover that are lying on the inside in the closed state of the housing are covered, in particular substantially completely, with a layer of superhydrophobic material. In addition to the advantages already explained, in particular in the case of an embodiment of the hard shell housing that is explained in more detail later and in which the interior space in the housing main body is divided into compartments by separating walls, the application of an inner superhydrophobic layer has the advantage that, in the event of a defective cell of a module, the other cells of this module can be protected better.

Within the scope of a further embodiment, the superhydrophobic material is integrated in the plastic of the housing main body or of the housing main body and of the housing cover. In particular, in this case the superhydrophobic material may be integrated in the plastic of the housing main body or of the housing cover, for example as a superhydrophobic layer, in such a way that the superhydrophobic material, for example in the form of a layer, surrounds the interior space of the housing substantially completely in the closed state of the housing.

The superhydrophobic material or the superhydrophobic layer may in particular be applied to the housing main body or the housing cover by a spraying process. In this case, the superhydrophobic material or the superhydrophobic layer may be applied to the housing main body and the housing cover in one spraying process step. It has been possible to observe particularly good mechanical strength when the plastic surface has been subjected in advance to a plasma and/or corona treatment.

The housing main body or the housing main body and the housing cover may in particular be formed at least substantially from a plastic which comprises at least one polymer selected from the group consisting of polyolefins, polyphenylene sulfides and combinations thereof. For example, the housing main body and the housing cover may be formed from polypropylene (PP), polyethylene (PE), polypropylene-polyethylene copolymer (PP/PE) or polyphenylene sulfide (PPS). These plastics advantageously have sufficient temperature resistance, good chemical resistance and good mechanical stability.

The housing main body or the housing cover may, for example, have a wall thickness of >100 μm.

The housing main body or the housing main body and the housing cover may, for example, be produced by a thermoforming process or injection-molding process, in particular an injection-molding process, in particular from plastic. The use of these processes for plastics makes it possible to realize many forms, which allow batteries to be accommodated more optimally, for example in vehicles.

Within the scope of a further embodiment, the interior space of the housing main body is divided by one or more plastic separating walls formed therein into compartments that are separated from one another, wherein the compartments are respectively designed for accommodating the cell components of a galvanic cell, in particular of a (lithium-ion) cell roll.

The plastic separating walls allow the cell components, in particular cell rolls, of a galvanic cell arranged in a compartment to be electrically insulated with respect to the cell components of galvanic cells arranged in neighboring compartments advantageously, in particular without a further method step.

Since the electrical insulation can be ensured by the plastic separating walls, the cell components or cell rolls can be introduced, in particular individually, into the various compartments, without further measures for the electrical insulation and without a short-circuit of the cells occurring, which may also have advantageous effects on the packing density.

Moreover, the plastic separating walls allow the mechanical stability of the hard shell housing to be increased further.

In addition, the plastic separating walls allow a defined pressure to be applied to the cell components, in particular cell rolls, which may be advantageous for proper functioning of the cells.

The surfaces bounding the compartments are also preferably covered, in particular substantially completely, with a layer of superhydrophobic material.

Within the scope of a further embodiment, the housing main body and the housing cover have connecting elements which are designed to form a tongue-and-groove plug-in connection when the housing is closed off. In particular, the connecting elements for forming the tongue-and-groove plug-in connection may run around the opening of the interior space in the housing main body, in particular around the full periphery or uninterruptedly. In this way, airtight closing of the hard shell housing and a good sealing effect can be advantageously achieved when the housing is closed off. In particular, at least one groove-shaped and/or tongue-shaped connecting element may be formed on the end faces of the walls of the housing main body that bound the opening of the interior space in the housing main body, in particular wherein the housing cover has connecting elements corresponding thereto for forming a tongue-and-groove plug-in connection.

In order to improve the sealing effect further within the scope of this embodiment, the connecting elements for forming the tongue-and-groove plug-in connection are preferably also partially or completely covered with a layer of superhydrophobic material or provided with superhydrophobic material integrated therein. In particular, when closing off the housing or when forming the tongue-and-groove plug-in connection, it may be provided that layers of superhydrophobic material covering the connecting elements can be placed against one another, for example pressed against one another. In this way, entry of moisture can be advantageously prevented particularly effectively and the moisture or vapor impermeability can be increased further.

Within the scope of a further embodiment, therefore, the connecting elements for forming the tongue-and-groove plug-in connection are partially or completely covered with a layer of superhydrophobic material or are provided with superhydrophobic material integrated therein.

Furthermore, the connecting elements may be designed for also forming a tongue-and-groove plug-in connection between the housing cover and the plastic separating wall or walls for dividing the interior space of the housing main body into compartments when the housing is closed off. In this way, galvanic cells arranged in the various compartments can be advantageously separated better from one another. In particular, at least one groove-shaped and/or tongue-shaped connecting element may be formed on the end faces of the plastic separating walls of the housing main body that divide the interior space in the housing main body into compartments, in particular wherein the housing cover has connecting elements corresponding thereto for forming a tongue-and-groove plug-in connection.

Furthermore, the hard shell housing may have a temperature-control device. The temperature-control device may for example take the form of a plate, for example the form of a cooling plate. In order to supply the temperature-control device with a temperature-control medium, in particular cooling medium, the hard shell housing may also have at least two, in particular externally accessible, hydraulic interfaces.

Furthermore, the hard shell housing may have at least two, in particular externally accessible, electrical interfaces (terminals), by way of which galvanic cells in the interior of the housing can be electrically contacted.

Within the scope of a further embodiment, the hard shell housing is designed as a hard shell cell housing for accommodating the cell components of a galvanic cell, in particular an individual galvanic cell, for example an alkali metal cell, for example a lithium cell, in particular a lithium-ion cell. In particular, the hard shell housing may be a hard shell cell housing for accommodating a cell roll, in particular an individual cell roll, for example a lithium-ion cell roll.

Within the scope of a further embodiment, the hard shell housing is designed as a hard shell battery housing for accommodating the cell components of two or more galvanic cells, for example alkali-metal cells, for example lithium cells, in particular lithium-ion cells. In particular, the hard shell housing may be a hard shell battery housing for accommodating two or more cell rolls, in particular lithium-ion cell rolls. In particular, the hard shell battery housing may be a hard shell module housing or a hard shell pack housing, in particular a hard shell module housing.

With regard to further embodiments and advantages of the hard shell housing according to the invention, reference is hereby made explicitly to the explanations in connection with the galvanic elements according to the invention, the method according to the invention and the figures.

A further subject matter of the present invention is a packaging film for a galvanic element which comprises at least one superhydrophobic material.

A superhydrophobic material advantageously allows an extremely high moisture or vapor impermeability of the packaging film to be achieved, and it may in particular be several orders of magnitude higher than in the case of hydrophobic materials or other moisture- or vapor-blocking materials. Moreover, a self-cleaning effect may be achieved by the superhydrophobic material.

The superhydrophobic material may be formed as a layer and/or be integrated in the plastic of the packaging film. In particular, the packaging film may have at least one layer of a superhydrophobic material. The superhydrophobic material may be formed in particular as a superhydrophobic, nanostructured layer. For example, the superhydrophobic material or the superhydrophobic (nanostructured) layer may be formed from at least one nanostructured polyolefin, for example nanostructured polypropylene (PP) and/or polyethylene (PE), and/or from at least one nanostructured semimetal, for example nanostructured silicon. In particular, the superhydrophobic material may be applied to the carrier layer by a spraying process.

Furthermore, the packaging film may have at least one carrier layer. The carrier layer may in particular be formed at least substantially, for example completely, from plastic. For example, the carrier layer may be formed at least substantially from plastic which comprises at least one polymer selected from the group consisting of polyolefins, polyphenylene sulfides and combinations thereof. For example, the carrier layer may be formed from polypropylene (PP), polyethylene (PE), polypropylene-polyethylene copolymer (PP/PE) or polyphenylene sulfide (PPS). These plastics advantageously have sufficient temperature resistance, good chemical resistance and good mechanical stability.

Within the scope of one embodiment, the surface of the packaging film, in particular of the carrier layer, that is lying on the outside in the packaged state is covered with a layer of superhydrophobic material.

Within the scope of a further alternative or additional embodiment, the surface of the packaging film, in particular of the carrier layer, that is lying on the inside in the packaged state is covered with a layer of superhydrophobic material.

Within the scope of a further alternative or additional embodiment, the superhydrophobic material is integrated in the carrier layer, in particular in the plastic of the carrier layer. In particular, in this case the superhydrophobic material may be integrated in the carrier layer, in particular the plastic of the carrier layer, in such a way that the superhydrophobic material surrounds the interior space of the housing substantially completely in the packaged state of the housing.

The superhydrophobic material may in particular take the form of a superhydrophobic, nanostructured layer. For example, the superhydrophobic material or the superhydrophobic, nanostructured layer may be formed from at least one nanostructured polyolefin, for example nanostructured polypropylene (PP) and/or polyethylene (PE), and/or from at least one nanostructured semimetal, for example nanostructured silicon. In particular, the superhydrophobic material may be applied to the carrier layer by a spraying process.

The packaging films may for example have a film thickness of ≧20 μm to ≦100 μm.

Within the scope of a further embodiment, the packaging film is formed as a pouch. In this way, assembly can be advantageously simplified.

With regard to further embodiments and advantages of the packaging film according to the invention, reference is hereby explicitly made to the explanations in connection with the galvanic elements according to the invention, the method according to the invention and the figures.

A further subject matter of the present invention is a galvanic element which comprises a hard shell housing according to the invention and/or a packaging film according to the invention. In particular, the cell components of at least one galvanic cell, in particular of two or more galvanic cells, may in this case be arranged in the interior space of the housing main body of the hard shell housing. For example, in this case at least one (lithium-ion) cell roll, in particular two or more (lithium-ion) cell rolls, may be arranged in the interior space of the housing main body of the hard shell housing.

The at least one galvanic cell may in particular be an alkali metal cell, for example a lithium cell. In particular, the at least one galvanic cell may be a lithium-ion cell. Within the scope of one configuration, at least one cell roll of a galvanic cell is arranged in the interior space of the housing main body. In particular, at least one lithium-ion cell roll may be arranged in the interior space of the housing main body.

A galvanic cell in the form of a lithium-ion cell may in particular comprise an anode of what is known as an intercalation material, into which lithium ions can be reversibly intercalated and deintercalated. For example, the anode of a lithium-ion cell may comprise a carbon-based intercalation material, such as graphite, graphene, carbon nanotubes, hard carbons, soft carbons and/or silicon-carbon blends. As cathode material, a lithium-ion cell may for example comprise transition metal oxides with a layer structure, such as lithium-cobalt oxide (LiCoO₂) and/or lithium-nickel-cobalt-manganese oxide (NCM). Furthermore, a lithium-ion cell may in particular comprise at least one conductive salt, for example lithium hexafluorophosphate (LiPF₆) and/or lithium tetrafluoroborate (LiBF₄), and possibly at least one solvent, for example ethylene carbonate (EC) and/or dimethyl carbonate (DMC). Between the anode and the cathode, a lithium-ion cell may in particular comprise a separator. For the electrical contacting of the anode and the cathode, a lithium-ion cell may in particular comprise electrical outgoing conductor foils. The anodic outgoing conductor foil may for example be formed from copper and the cathodic outgoing conductor foil may be formed from aluminum.

Within the scope of further embodiments, the galvanic element comprises the cell components of two or more galvanic cells, in particular at least two (lithium-ion) cell rolls. Within the scope of these embodiments, the galvanic element may also be referred to as a module, pack or battery.

Within the scope of one configuration of this embodiment, the interior space of the housing main body is divided by one or more plastic separating walls formed therein into compartments that are separated from one another. In this case, the cell components of the galvanic cells, in particular the (lithium-ion) cell rolls, may in particular be arranged in different compartments.

Within the scope of another alternative or additional configuration of this embodiment, the cell components of the galvanic cells, in particular the lithium-ion cell rolls, are packaged in each case separately from one another in plastic packaging films, wherein the cell components of the galvanic cells, in particular (lithium-ion) cell rolls, packaged in plastic packaging films are arranged in the housing main body.

The plastic packaging films allow the cell components, in particular the cell roll, of the galvanic cells to be electrically insulated with respect to neighboring galvanic cells advantageously, in particular without a further method step. Since the electrical insulation can be ensured by the plastic packaging films, the plastic packaging films of two or more galvanic cells, respectively packaged separately from one another, can come into contact with one another, without a short-circuit occurring. In this way, a galvanic element with a high packing density can in turn be advantageously provided.

Moreover, the plastic packaging films can allow a defined pressure to be applied to the cell components, in particular cell roll, which may be advantageous for proper functioning of the cells.

The fact that the cell components packaged in plastic packaging films are arranged in the interior space of the housing main body of the hard shell housing that can be closed off by the housing cover and that the cells are not installed in the conventional open module type of construction means that protection from mechanical effects can be advantageously ensured, which is advantageous in particular for use in mobile applications, such as in vehicles.

Altogether, this embodiment advantageously makes it possible to dispense with a metallic housing and to minimize further the weight and the costs of material and production.

Within the scope of a special configuration, the plastic packaging films comprise at least one polar-modified, in particular grafted, polyolefin, for example polypropylene, for example maleic acid grafted polypropylene. In particular, the plastic packaging films may be formed from at least one polar-modified, in particular grafted, polyolefin, for example polypropylene, for example maleic acid grafted polypropylene.

Polar-modified polyolefins may advantageously have extremely high bonding to metals. This advantageously allows a good sealing effect to be achieved between plastic packaging films and metallic outgoing conductor elements, for example outgoing conductor pins, known as collectors, for example of copper, aluminum or nickel.

The cell components, in particular the cell roll, of the individual galvanic cells may for example be welded respectively in plastic packaging films.

The plastic packaging films may be advantageously made thin, and have for example a film thickness of ≧20 μm to ≦100 μm.

Within the scope of one configuration, the plastic packaging films also comprise at least one superhydrophobic material. In particular, the plastic packaging films may be packaging films according to the invention. The superhydrophobic material may be integrated in the plastic of the packaging film and/or be formed as a layer which for example covers the outer side and/or inner side of the packaging film. The superhydrophobic material may be formed in particular as a superhydrophobic, nanostructured layer. For example, the superhydrophobic material or the superhydrophobic, nanostructured layer may be formed from at least one nanostructured polyolefin, for example nanostructured polypropylene (PP) and/or polyethylene (PE), and/or from at least one nanostructured semimetal, for example nanostructured silicon. In particular, the superhydrophobic material may be applied to a plastic (carrier) layer of the plastic packaging film by a spraying process.

Two or more galvanic cells are preferably electrically interconnected, for example in series and/or in parallel, in particular to form a module, in the interior space of the hard shell housing. In this way, the inner electrical connections can be advantageously protected.

Electrical contacting of the cells interconnected in the interior space may take place in particular by way of the at least two, in particular externally accessible, electrical interfaces (terminals). In this way, the total number of connections can be reduced to a few connections, for example for power, control/diagnostics and temperature control, which makes the galvanic element a more functional unit. Among other effects, this also simplifies assembly, for example in that fewer working steps have to be carried out in the high-voltage area. By optimizing connections, the moisture or vapor impermeability of the hard shell housing can also be advantageously improved further.

With regard to further embodiments and advantages of the galvanic elements according to the invention, reference is hereby made explicitly to the explanations in connection with the hard shell housing according to the invention, the packaging film according to the invention, the method according to the invention and the figures.

A further subject matter of the present invention is a method for producing a galvanic element according to the invention which comprises the following method steps:
a) forming/providing a housing main body, with an interior space for accommodating the cell components of at least one galvanic cell of plastic and possibly a housing cover for closing off the interior space of the housing main body of plastic, and/or forming/providing a carrier film, in particular a (plastic) carrier film;
b) introducing the cell components of at least one galvanic cell, in particular of at least one (lithium-ion) cell roll, into the interior space of the housing main body, and/or enclosing the cell components of at least one galvanic cell, in particular at least one (lithium-ion) cell roll, with the carrier film; and
c) closing off, in particular closing off in an airtight manner, the interior space of the housing main body with the closure cover, and/or an interior space enclosed by the carrier film,
   wherein, in method step a) and/or in a method step d), taking place after method step c), the plastic of the housing main body or the plastic of the housing main body and of the housing cover and/or the carrier film, in particular the plastic of the carrier film, is provided or coated with at least one layer of a superhydrophobic material, for example by a spraying process, and/or
   wherein, in method step a), at least one superhydrophobic material is integrated into the plastic of the housing main body or into the plastic of the housing main body and of the housing cover and/or into the carrier film, in particular into the plastic of the carrier film.

Between method steps c) and d), the method may also have the method step c1) of connecting the housing cover with a material bond, in particular by welding, for example plasma welding, to the housing main body. In particular, in this case a continuous, in particular uninterrupted and/or peripheral, material-bonding connecting region may be created, for example in the form of a peripheral weld seam. In this way, the moisture or vapor impermeability can be advantageously improved further. In a subsequent method step d), the material-bonding connecting region may advantageously be likewise coated with the at least one superhydrophobic material.

In order to improve the bonding of a layer of superhydrophobic material on the plastic of the housing main body and of the housing cover, it may be advantageous to subject the plastic surface of the housing main body and of the housing cover to a plasma and/or corona treatment before the application of the superhydrophobic layer.

Within the scope of one configuration, in method step a) the interior space of the housing main body is divided by the formation of one or more plastic separating walls into compartments that are separated from one another. In this case, in method step b), the cell components of two or more galvanic cells, in particular two or more (lithium-ion) cell rolls, may be introduced into different compartments.

Within the scope of another alternative or additional configuration, in method step b), two or more galvanic cells, the cell components, in particular cell rolls, of which are respectively packaged separately from one another in plastic packaging films, are introduced into the interior space of the housing main body.

Within the scope of one configuration of this, the packaging of the cell components of a galvanic cell, in particular of a cell roll, is performed by the cell components of a galvanic cell, in particular a cell roll, being introduced into a pouch-shaped plastic packaging film, the opening of which is subsequently closed off, for example by welding. In particular, this may be a packaging film according to the invention.

For the electrical contacting of the cell components of a galvanic cell, the galvanic cell may in particular comprise electrical outgoing conductor elements. These may for example take the form of outgoing conductor foils, outgoing conductor pins (collectors), outgoing conductor cables and outgoing conductor plates.

In the case of a cell roll, it may be for example that electrical outgoing conductor foils that are integrated in the winding are electrically contacted by two electrical outgoing conductor pins (collectors) being inserted into the cell roll at positions at which they respectively electrically contact one of the outgoing conductor foils (cathodic or anodic outgoing conductor foil). The outgoing conductor pins (collectors) may in particular be respectively formed from the same material as the outgoing conductor foil to be contacted therewith. For example, a cathodic outgoing conductor foil of aluminum may be electrically contacted with an outgoing conductor pin (collectors) of aluminum and an anodic outgoing conductor foil of copper may be electrically contacted with an outgoing conductor pin (collectors) of copper. The direction of insertion of the outgoing conductor pins (collectors) may in this case be for example parallel to the axis of the winding.

The insertion of the outgoing conductor pins (collectors) may in principle take place both before and after the packaging of the cell components of a galvanic cell, in particular of a cell roll, in a plastic packaging film.

A further subject matter of the present invention is a galvanic element produced by a method according to the invention.

A further subject matter of the present invention is a mobile or stationary system, for example a vehicle, which comprises at least one galvanic element according to the invention.

With regard to further embodiments and advantages of the method according to the invention, the galvanic element thereby produced and the mobile or stationary system according to the invention, reference is hereby made explicitly to the explanations in connection with the hard shell housing according to the invention, the packaging film according to the invention, the galvanic element according to the invention and the figures.

### DRAWINGS AND EXAMPLES

Further advantages and advantageous configurations of the subjects according to the invention are illustrated by the drawings and are explained in the description that follows. It should be noted that the drawings are only of a descriptive character and are not intended to restrict the invention in any form. In the drawings:

FIG. 1 shows a schematic perspective view of an embodiment of the hard shell housing and galvanic element according to the invention, for and with an individual galvanic cell;

FIG. 2a shows a schematic perspective view of a further embodiment of the hard shell housing and galvanic element according to the invention, for and with six galvanic cells interconnected in series;

FIG. 2b shows a schematic perspective view of a further embodiment of the hard shell housing and galvanic element according to the invention, for and with six galvanic cells interconnected in parallel;

FIGS. 3a-6 show schematic views to illustrate an embodiment of the method according to the invention which is designed for producing the hard shell housing and galvanic element shown in FIG. 1;

FIGS. 7a-13 show schematic views to illustrate an embodiment of the method according to the invention which is designed for producing the hard shell housing and galvanic elements shown in FIGS. 2a and 2b;

FIG. 14 shows a schematic perspective view of an embodiment of the hard shell housing according to the invention in which the interior space in the housing main body is divided by separating walls into compartments that are separated from one another for accommodating in each case a cell roll;

FIG. 15 shows a schematic cross section through an embodiment of the hard shell housing according to the invention in which the housing main body and the housing cover are provided with connecting elements for forming a tongue-and-groove plug-in connection for closing off the housing in an airtight manner;

FIGS. 16a-16c show schematic cross-sectional views to illustrate the interaction of a water droplet with a superhydrophobic, hydrophobic and hydrophilic material.

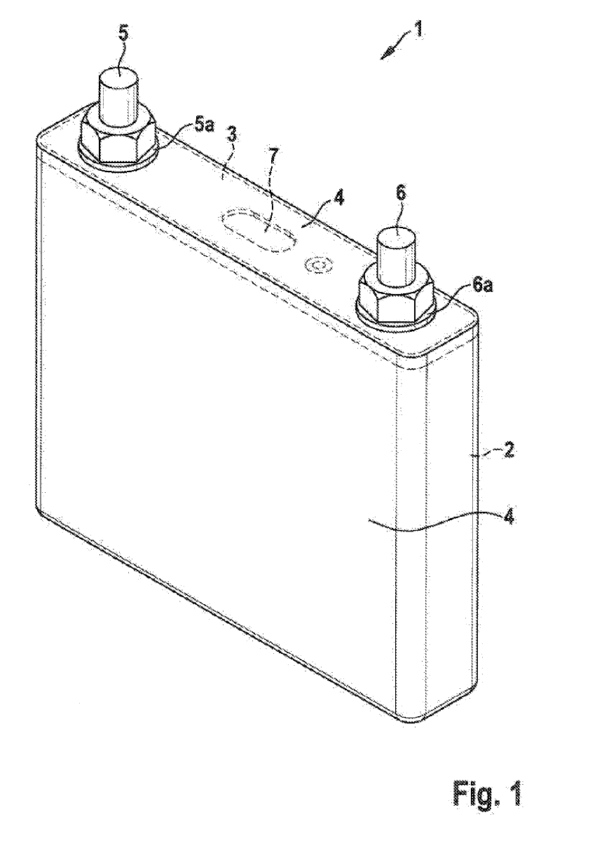

FIG. 1 shows a galvanic element 1 with a hard shell cell housing, by which the cell components of an individual galvanic cell are protected from environmental influences. The galvanic cell may in particular be a lithium-ion cell. The cell components of the galvanic cell may in this case be formed in particular as a cell roll.

FIG. 1 illustrates that the hard shell housing has a housing main body 2 with an interior space (not represented) for accommodating the cell components of the galvanic cell and a housing cover 3 for closing off the interior space of the housing main body 2. In this case, the housing main body 2 and the housing cover 3 are formed substantially from plastic. The surfaces of the housing main body 2 and of the housing cover 3 that are on the outside in the closed state shown of the housing are in this case covered substantially completely with a layer 4 of superhydrophobic material, which has been applied to the plastic of the housing main body 2 and of the housing cover 3 by a spraying process after the introduction of the cell components into the interior space of the housing main body 2 and after the closing off of the interior space of the housing main body 2 with the housing cover 3. Substantially complete covering of the surfaces of the housing main body 2 and of the housing cover 3 that are on the outside in the closed state with a layer can be understood in this case as meaning that portions of the surface of the housing main body 2 and of the housing cover 3 that are already covered by other components, for example washers 5a, 6a for the mechanical fastening of the electrical interfaces (terminals) 5, 6, may remain uncoated during the spraying operation. This is so because penetration of moisture can be ensured even in this case, since on the one hand the covering components may have a vapor-blocking effect and on the other hand the covering components, even without themselves having a vapor-blocking effect, may likewise be provided with the superhydrophobic layer, and consequently with a vapor-blocking effect, by the subsequent spraying. Since the join between the housing main body 2 and the housing cover 3 and also a safety valve 7 lie under the superhydrophobic layer 4, these are indicated by dashed lines.

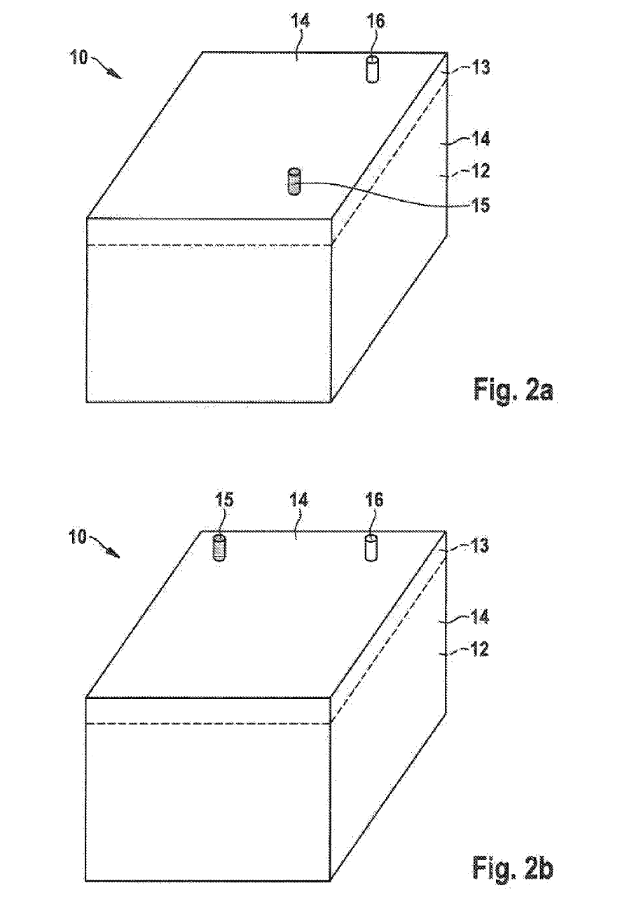

FIG. 2a shows a galvanic element, in particular a module, 10 with a hard shell module housing 10, by which the cell components of six galvanic cells interconnected in series are protected from environmental influences. FIG. 2b shows a similar module 10, which differs from the module 10 shown in FIG. 2a in that the cells are interconnected in parallel instead of in series, and therefore the electrical interfaces (terminals) 15, 16 are formed in different positions. Here, too, the galvanic cells may be lithium-ion cells. The cell components of the galvanic cell may in particular likewise take the form of cell rolls.

FIGS. 2a and 2b illustrate that the hard shell housings have a housing main body 12 with an interior space (not represented) for accommodating the cell components of the galvanic cells and a housing cover 13 for closing off the interior space of the housing main body 12. In this case, the housing main bodies 12 and housing covers 13 are formed substantially from plastic. The surfaces of the housing main bodies 12 and housing covers 13 that are on the outside in the closed state shown of the housings are in this case respectively covered substantially completely with a layer 14 of superhydrophobic material, which has been applied to the plastic of the housing main bodies 12 and housing covers 13 by a spraying process after the introduction of the cell components into the interior space of the housing main bodies 12 and after the closing off of the interior spaces of the housing main bodies 12 with the housing covers 13. Since the joins between the housing main bodies 12 and housing covers 13 lie under the superhydrophobic layers 14, they are indicated by dashed lines.

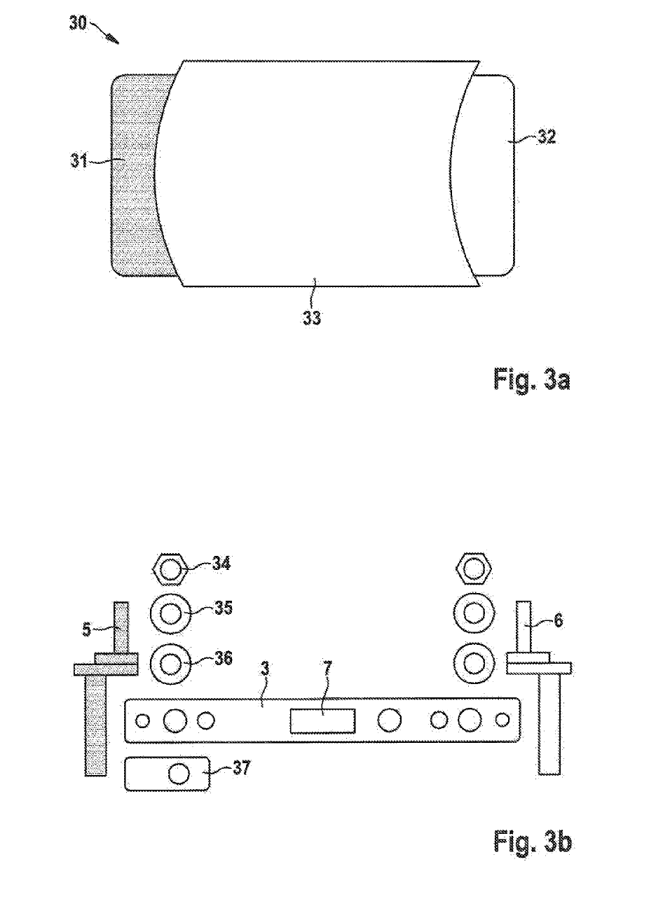

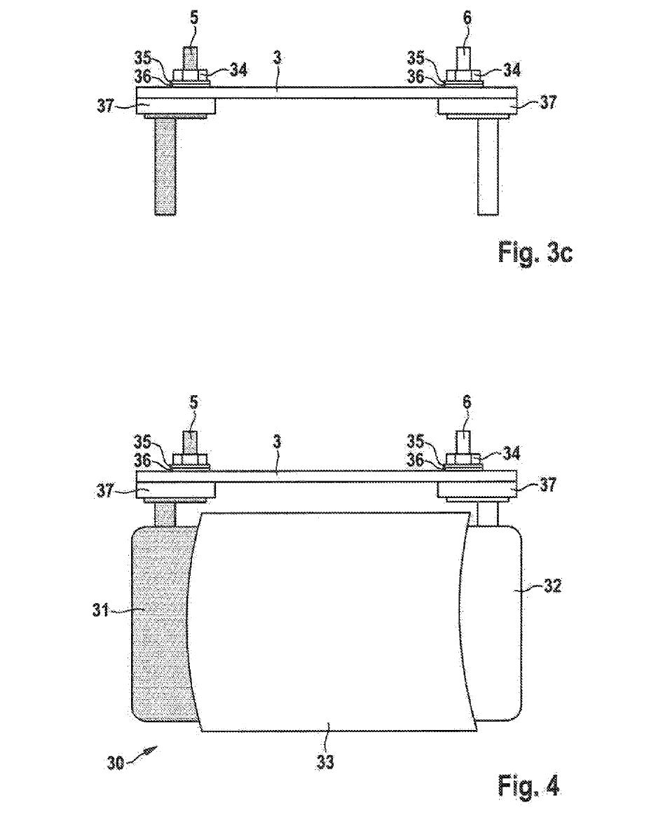

FIGS. 3a to 6 illustrate an embodiment of the method according to the invention that is designed for producing the hard shell cell housing or galvanic element shown in FIG. 1.

FIG. 3a shows that a cell roll 30, for example a lithium-ion cell roll, is provided, having a winding axis perpendicular to the lower edge of the page and wound in such a way that both the anodic outgoing conductor foil 31 of copper and the cathodic outgoing conductor foil 32 of aluminum are externally accessible. The cell roll 30 is held together by a film 33 of an electrically insulating material.

FIGS. 3b and 3c show a possible way of forming and arranging outgoing conducting elements for the electrical contacting of the anodic outgoing conductor foil 31 and cathodic outgoing conductor foil 32 of the cell roll 30 shown in FIG. 3a. In this case, FIG. 3b shows the outgoing conductor elements in the individually separated state and FIG. 3c shows the outgoing conductor elements in the assembled state. The outgoing conductor elements 5, 6 are formed on the one hand as electrical interfaces (terminals) for the electrical contacting outside the housing and on the other hand as outgoing conductor pins (collectors) for the electrical contacting of the outgoing conductor foils 31, 32 inside the housing. In this case, the outgoing conductor elements 5, 6 are respectively formed from the same material as the outgoing conductor foil 31, 32 to be contacted therewith. FIGS. 3b and 3c illustrate that the outgoing conductor elements 5, 6 can be respectively led through an opening in a housing cover 3. In the case where the housing cover is formed from metal, for example aluminum, the insulating elements 36, 37 are provided in order to insulate the outgoing conductor elements 5, 6 electrically from the housing cover. In the case of a housing cover formed from plastic, it is advantageously possible to dispense with the insulating elements 36, 37, which reduces further the weight and the costs of material and assembly. FIGS. 3b and 3c also illustrate that the outgoing conductor elements 5, 6 are mechanically connected to the housing cover 3 by fastening elements 34, 35. Within the scope of the embodiment shown, the mechanical fastening takes place by a screw connection, the outgoing conductor elements 5, 6 being provided with an external thread and interacting with nuts corresponding thereto and also possibly washers 35.

FIG. 4 shows that, in the state in which they are installed with the cover 3, the outgoing conductor elements shown in FIGS. 3b and 3c can be inserted into the cell roll 30 shown in FIG. 3a in such a way that one outgoing conductor element 5 electrically contacts the anodic outgoing conductor foil and the other outgoing conductor element 6 electrically contacts the cathodic outgoing conductor foil.

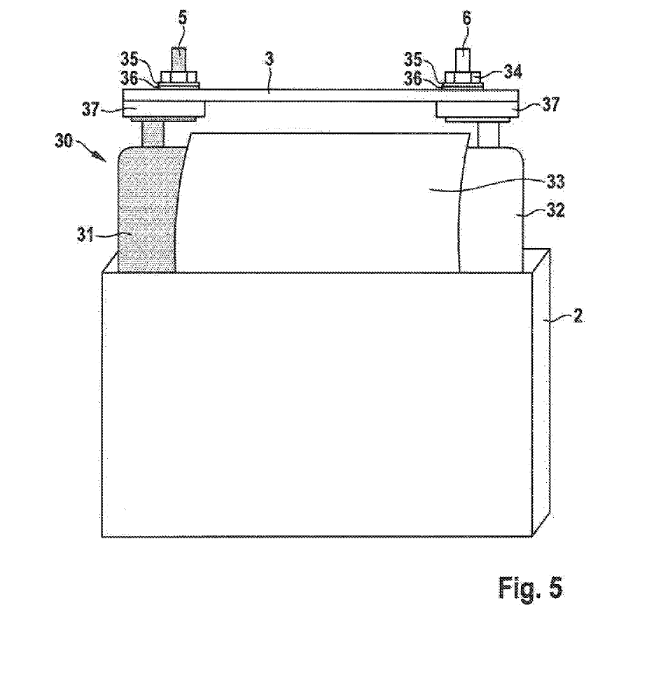

FIG. 5 illustrates that the arrangement shown in FIG. 4 is introduced into the interior space of a housing main body 2 in such a way that the housing cover 3 closes off the interior space of the housing main body 2 after the cell roll 30 has been introduced completely.

In the case of a rebated configuration of the housing main body 2 and of the housing cover 3, shown for example in FIG. 15, the interior space of the housing main body 2 may already be closed off in an airtight manner by joining together the two housing components. However, it is similarly possible to weld the housing main body 2 and the housing cover 3 to one another, for example by plasma welding, or to adhesively bond them.

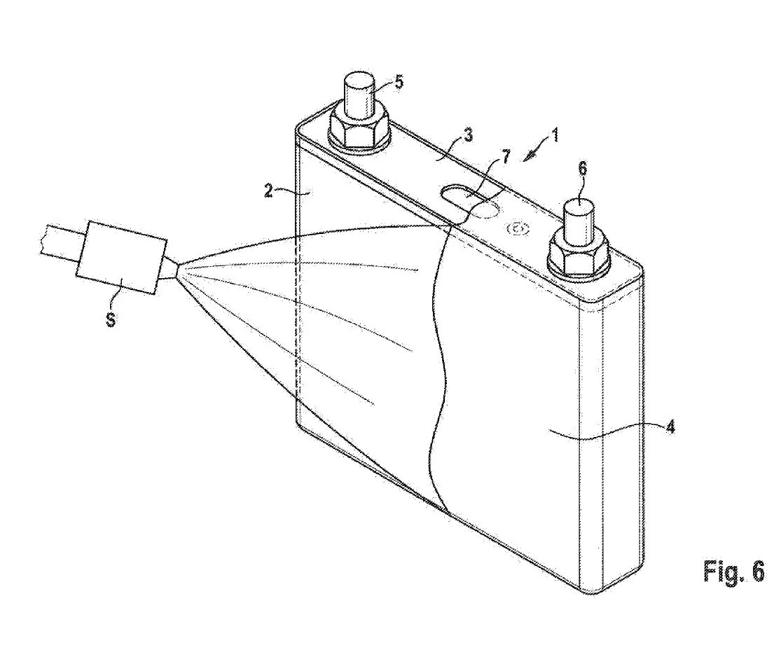

FIG. 6 illustrates that, after the hard shell housing has been closed off, the outer surfaces of the housing main body 2 and of the housing cover 3 and also the join and possibly components neighboring the join, such as the washers 35, are provided with a layer 4 of a superhydrophobic material by a spraying process.

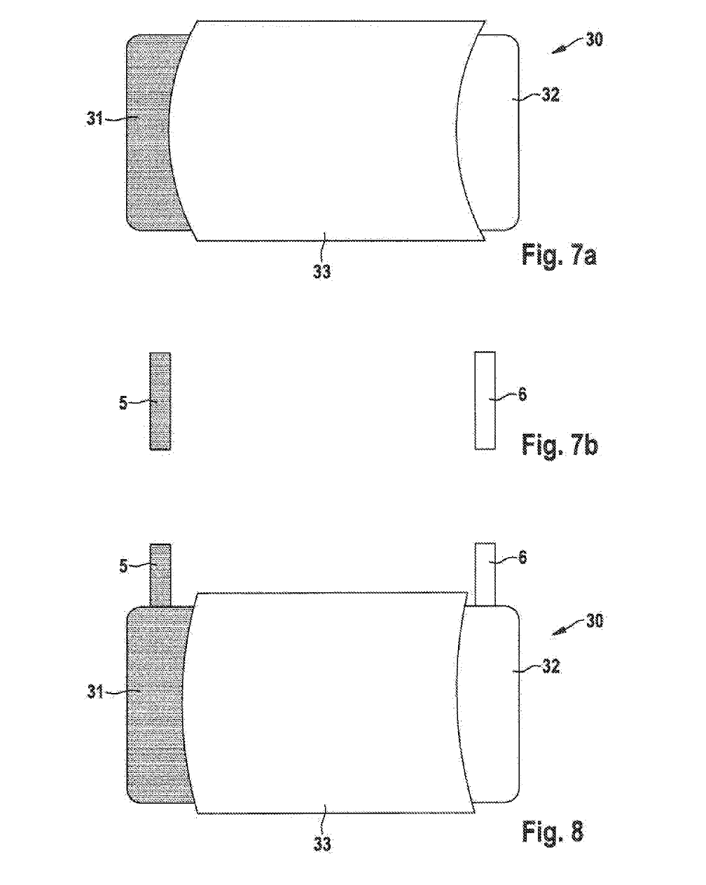

FIGS. 7a to 13 illustrate an embodiment of the method according to the invention which is designed for producing the hard shell battery housing and module shown in FIGS. 2a and 2b.

FIG. 7a shows that a cell roll 30, for example a lithium-ion cell roll, is likewise provided, having a winding axis perpendicular to the lower edge of the page and wound in such a way that both the anodic outgoing conductor foil 31 of copper and the cathodic outgoing conductor foil 32 are externally accessible, and being held together by a film 33 of an electrically insulating material.

FIG. 7b shows outgoing conducting elements 5, 6 for the electrical contacting of the anodic outgoing conductor foil 31 and cathodic outgoing conductor foil 32 of the cell roll 30 shown in FIG. 7a, which are formed as outgoing conductor pins (collectors) 5, 6 for the electrical contacting of the outgoing conductor foils 31, 32 within the housing.

FIG. 8 shows that the outgoing conductor elements 5, 6 shown in FIG. 7b can be inserted into the cell roll 30 shown in FIG. 7a in such a way that one outgoing conductor pin (collector) 5 electrically contacts the anodic outgoing conductor foil and the other outgoing conductor pin (collector) 6 electrically contacts the cathodic outgoing conductor foil.

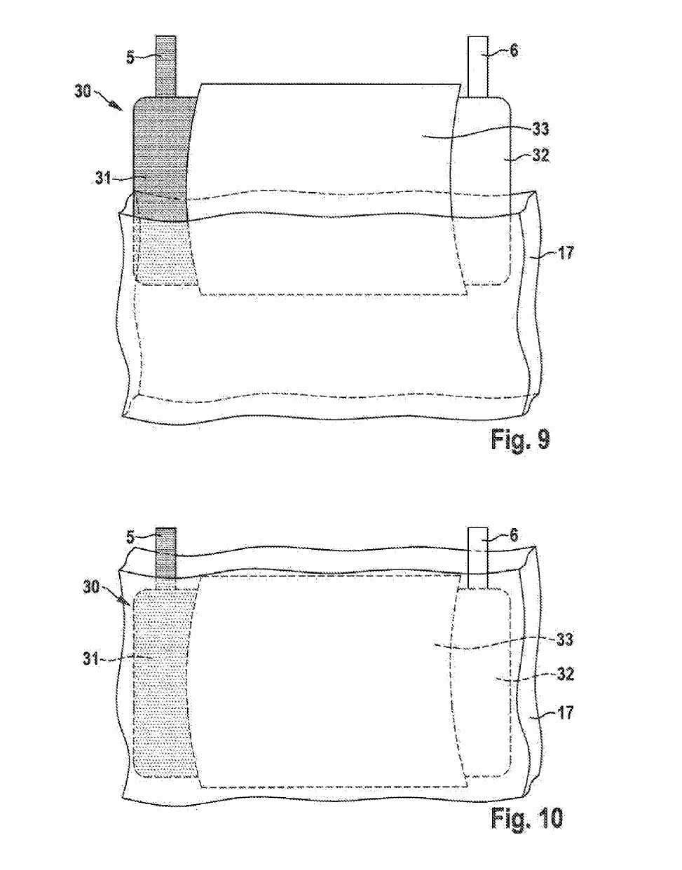

FIG. 9 illustrates that the arrangement shown in FIG. 8 is introduced into a pouch-shaped plastic packaging film 17.

FIG. 10 illustrates that, after the introduction of the arrangement shown in FIG. 8 into the pouch-shaped plastic packaging film 17, the outgoing conductor pins (collectors) 5, 6 partially protrude from the plastic film pouch 17. The opening of the plastic film pouch 17 may be subsequently welded for example. However, it is similarly possible in principle first to introduce the cell roll 30 into the plastic film pouch 17 and close it off, and only then insert the outgoing conductor pins (collectors) 5, 6 into the cell roll. For this, it is advantageous in particular if the plastic film pouch 17 is formed from a transparent material. Maleic acid grafted polypropylene is suitable in particular as the material for the plastic film pouch 17, since it bonds well to the metallic outgoing conductor pins (collectors) 5, 6, and consequently a good sealing effect can be achieved.

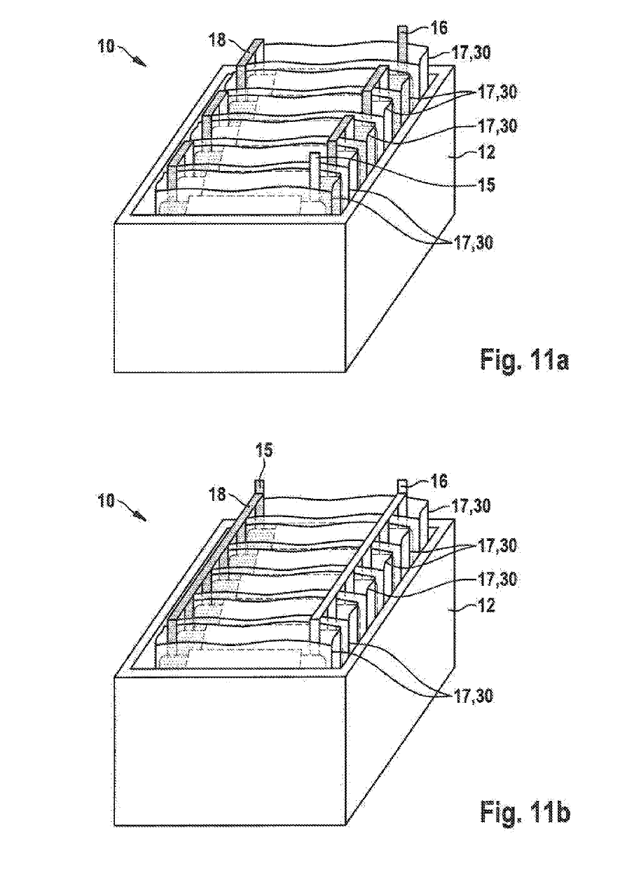

FIGS. 11a and 11b illustrate that six cell rolls 30 packaged in plastic packaging films 17 have been introduced into a housing main body 12, the cell rolls shown in FIG. 11a having been interconnected in series and the cell rolls 30 shown in FIG. 11b having been interconnected in parallel 18, and provided with electrical interfaces (terminals) 15, 16.

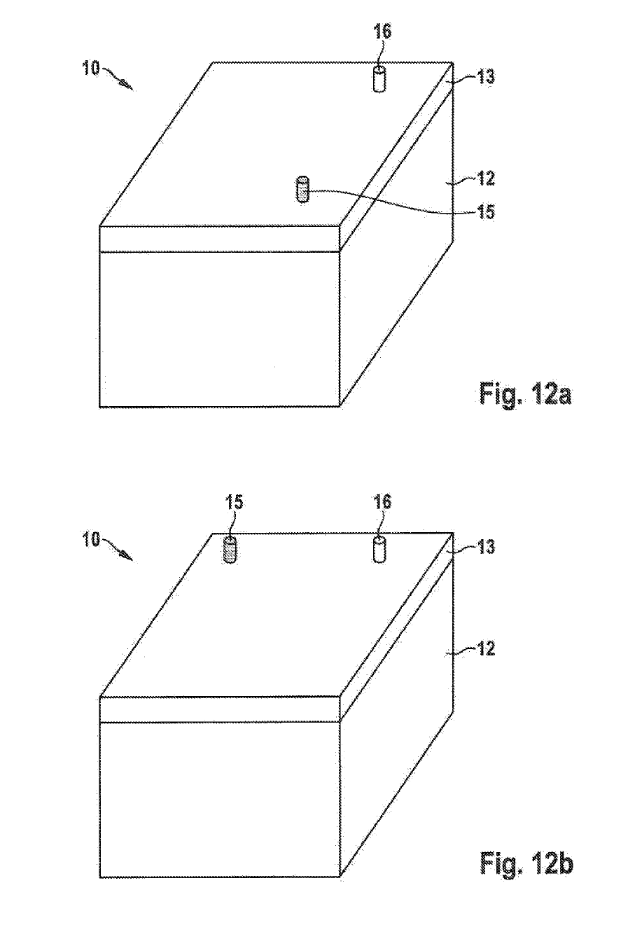

FIGS. 12a and 12b show that, after the interior spaces of the housing main bodies 12 have been closed off by housing covers 13, the electrical interfaces (terminals) 15, 16 are externally accessible. The outgoing conductor pins (collectors) 5, 6 and also their electrical interconnection are however arranged in a protected manner in the interior space of the housing. FIGS. 12a and 12b also illustrate that the position of the electrical interfaces (terminals) 15, 16 can vary in dependence on the type of interconnection.

In the case of a rebated configuration of the housing main body 12 and of the housing cover 13, shown for example in FIG. 15, the interior space of the housing main body 12 may already be closed off in an airtight manner by joining together the two housing components. However, it is similarly possible to weld the housing main body 12 and the housing cover 13 to one another, for example by plasma welding.

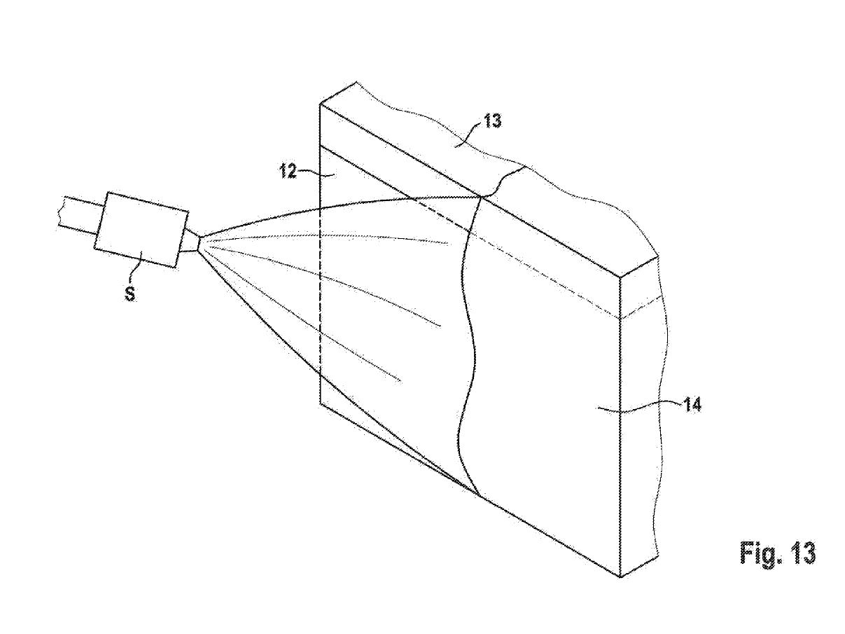

FIG. 13 illustrates that, after the hard shell housing has been closed off, the outer surfaces of the housing main body 12 and of the housing cover 13 and also the join and possibly components neighboring the join are provided with a layer 14 of a superhydrophobic material by a spraying process.

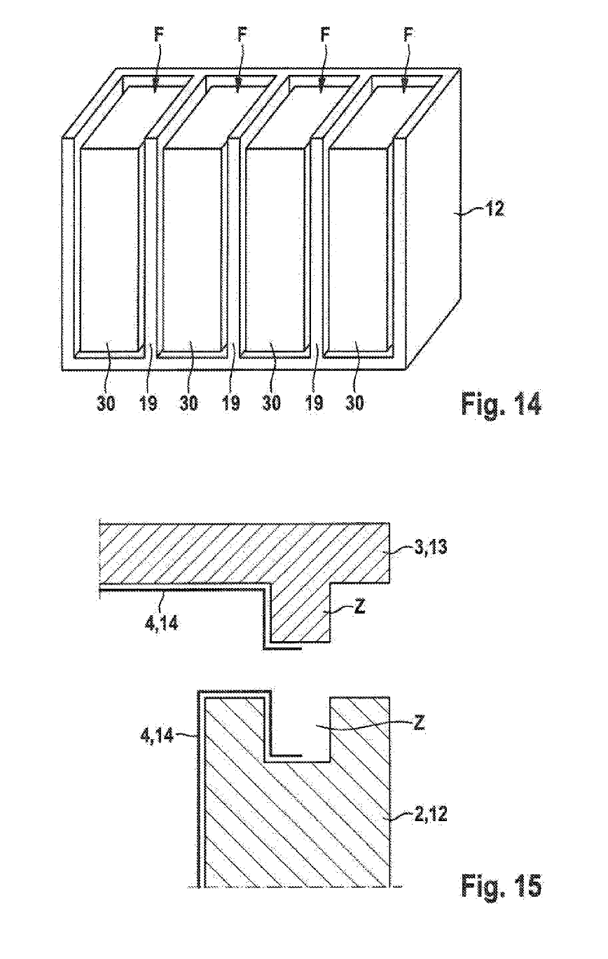

FIG. 14 shows a further embodiment of a hard shell battery housing in which the interior space of the housing main body 12 is divided by separating walls 19 into compartments F that are separated from one another and can respectively accommodate a cell roll 30.

FIG. 15 shows a further embodiment of a hard shell cell or module housing in which the housing main body 2, 12 and the housing cover 3, 13 are provided with connecting elements Z for forming a tongue-and-groove plug-in connection for closing off the housing in an airtight manner. In this case, the connecting elements Z preferably run around the opening of the interior space in the housing main body 2, 12. The connecting elements Z are in this case likewise at least partially covered with the layer 4, 14 of superhydrophobic material in such a way that, when forming the plug-in connection, the superhydrophobic layers of the connecting elements of the housing main body 2, 12 and of the housing cover 3, 13 lie against one another. In this way, a particularly good sealing effect can be advantageously achieved.

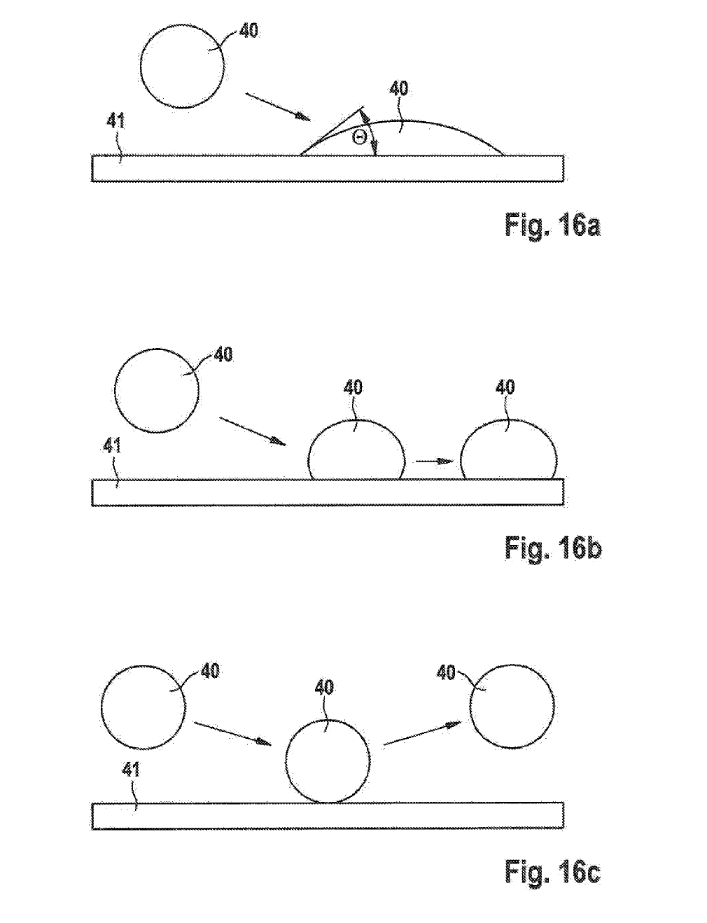

FIGS. 16a to 16c show schematic cross-sectional views to illustrate the interaction of a water droplet 40 with a layer of material 41. In this case, a layer of hydrophilic material 41 is shown in FIG. 16a, a layer of hydrophobic material 41 is shown in FIG. 16b and a layer of superhydrophobic material 41 is shown in FIG. 16c. FIG. 16a also illustrates that, in the case of a layer of hydrophilic material, the contact angle θ is small and significantly below 90°. FIG. 16b illustrates that the contact angle θ in the case of a layer of hydrophobic material is greater than in the case of a layer of hydrophilic material and is around 90°. FIG. 16c illustrates that the contact angle θ in the case of a layer of superhydrophobic material is greater than in the case of a layer of hydrophobic material and may be more than 135°, for example approximately 160°. FIG. 16c also shows that the water droplet 40 is repelled by the layer of superhydrophobic material 41 and cannot penetrate into the layer of material 41.

1. A hard shell housing for a galvanic element, comprising:
a housing main body with an interior space configured to accommodate cell components of at least one galvanic cell, and
a housing cover configured to close off the interior space of the housing main body,
wherein the housing main body is formed at least substantially from plastic and comprises at least one superhydrophobic material.

2. The hard shell housing as claimed in claim 1, wherein the at least one galvanic cell is a lithium-ion cell.

3. The hard shell housing as claimed in claim 1, wherein the interior space of the housing main body is configured to accommodate at least one cell roll of a galvanic cell.

4. The hard shell housing as claimed in claim 1, wherein the superhydrophobic material is a superhydrophobic nanostructured layer.

5. The hard shell housing as claimed in claim 1, wherein the superhydrophobic material comprises at least one of:
(i) at least one of nanostructured polypropylene and nanostructured polyethylene; and
(ii) at least one nanostructured silicon.

6. The hard shell housing as claimed in claim 1, wherein the housing cover is formed at least substantially from the plastic, and comprises the at least one superhydrophobic material.

7. The hard shell housing as claimed in claim 1, wherein at least one of:
at least surfaces of (i) the housing main body or of (ii) the housing main body and the housing cover, that are located on an outside of the housing main body in a closed state are covered with a layer of superhydrophobic material,
at least surfaces of (i) the housing main body or of (ii) the housing main body and the housing cover, that are located on an inside of the housing main body in the closed state are covered with a layer of superhydrophobic material, and
the superhydrophobic material is integrated in the plastic of (i) the housing main body or (ii) the housing main body and the housing cover, such that the superhydrophobic material surrounds the interior space of the housing main body substantially completely in the closed state.

8. The hard shell housing as claimed in claim 1, wherein:
one or more plastic separating walls located within the interior space body divide the interior space into compartments that are separated from each other; and
each of the compartments is respectively configured to accommodate the cell components of a respective galvanic cell.

9. The hard shell housing as claimed in claim 1, wherein:
the housing main body and the housing cover have connecting elements configured to form a tongue-and-groove plug-in connection when the housing is closed off,
the connecting elements extend around an opening of the interior space in the housing main body, and
the connecting elements are covered by a layer of superhydrophobic material or have superhydrophobic material integrated therein.

10. The hard shell housing as claimed in claim 1, wherein:
the hard shell housing is configured to accommodate cell components of a lithium-ion cell, or
the hard shell housing is a hard shell module housing configured to accommodate cell components of two or more lithium-ion cells.

11. A packaging film for a galvanic element, comprising at least one superhydrophobic material:
wherein at least one of:
a surface of the packaging film that is located on an outside of the packaging film in a packaged state is covered with a layer of superhydrophobic material,
a surface of the packaging film that is located on an inside of the packaging film in the packaged state is covered with a layer of superhydrophobic material, and
the superhydrophobic material is integrated in a carrier layer, and
wherein the packaging film has a substantially pouch-like shape.

12. The hard shell housing as claimed in claim 1, further comprising:
cell components of at least one galvanic cell positioned in at least one of:
(i) the interior space of the housing main body; and
(ii) a packaging film comprising at least one superhydrophobic material:
wherein at least one of:
a surface of the packaging film that is located on an outside of the packaging film in a packaged state is covered with a layer of superhydrophobic material; and
a surface of the packaging film that is located on an inside of the packaging film in the packaged state is covered with a layer of superhydrophobic material; and
the superhydrophobic material is integrated in a carrier layer, and wherein the packaging film has a substantially pouch-like shape.

13. The hard shell housing as claimed in claim 12, wherein:
the hard shell housing comprises cell components of at least two lithium-ion cell rolls,
one or more plastic separating walls located within the interior space divide the interior space into compartments that are separated from each other, and
the cell components of the lithium-ion cell rolls are positioned in different compartments.

14. The hard shell housing as claimed in claim 12, wherein:
the hard shell housing comprises cell components of at least two lithium-ion cell rolls,
the cell components of the lithium-ion cell rolls are respectively packaged separately from each other in a respective one of the packaging film,
the cell components of the lithium-ion cell rolls, packaged in the respective packaging films, are positioned in the housing main body, and
respective packaging films comprise at least one maleic acid grafted polypropylene.

15. A method for producing a galvanic element, comprising:
at least one of:
introducing cell components of at least one lithium-ion cell roll into an interior space of a housing main body of at least one galvanic cell, wherein the interior space is configured to accommodate the cell components, and wherein at least one of (i) the housing main body and (ii) a housing cover configured to close off the interior space is at least substantially formed from plastic; and
enclosing cell components of at least one lithium-ion cell roll with a carrier film; and
closing off, in an airtight manner, at least one of the interior space of the housing main body with the housing cover and an interior space enclosed by the carrier film; and
at least one of:
before the introducing or after the closing off, disposing at least one layer of a superhydrophobic material on at least one of (i) the plastic of the housing main body, (ii) the plastic of the housing cover, and (iii) the carrier film; and
before the introducing, integrating at least one superhydrophobic material into at least one of (i) the plastic of the housing main body, (ii) the plastic of the housing cover, and (iii) the carrier film.
